(19) United States
(12) Patent Application Publication
(10) Pub. No.: US 2025/0024963 A1
(43) Pub. Date: Jan. 23, 2025

(54) Baby Pillow

(71) Applicant: TECHNOLOGY CONSULTANTS LLC, Clarksboro, NJ (US)

(72) Inventor: Mickal Singh, Deptford, NJ (US)

(21) Appl. No.: 18/515,481

(22) Filed: Nov. 21, 2023

Related U.S. Application Data
(63) Continuation-in-part of application No. 29/905,475, filed on Oct. 20, 2023.
(60) Provisional application No. 63/514,747, filed on Jul. 20, 2023.

(51) Int. Cl. A47D 13/08; A61J 9/06

(52) U.S. Cl. CPC A47D 13/083; A61J 9/0638; A61J 9/0669

(57) ABSTRACT

A baby pillow having a first arm, second arm, bottle holder, and an attachment cushion. The first arm and second arm flare outwards to encircle the head of a wearer. The first arm and second arm are detachably attachable at the rear end to adjustably secure the baby pillow behind the head of the wearer. The bottle holder is positioned at the front of the pillow, having a divot positioned between two ears to hold a bottle. An elastic band arches over the two ears to adjustably secure a bottle into the bottle holder. The divot is slanted downwards to ensure the bottle slants down towards the mouth of the wearer. The attachment cushion is detachably attachable to the bottom of the baby pillow for height adjustment.

### FIELD OF THE INVENTION

The present invention relates generally to child feeding accessories, and specifically to a pillow for self-feeding of infants.

### BACKGROUND OF THE INVENTION

Feeding children using bottles can be a tiresome, lengthy process that produces strain on the arms of the caretaker. It is desirable to have a safe, comfortable way for a parent or caretaker to feed a child using bottle without the need for the caretaker to hold the bottle in place.

The present invention aims to provide a safe, comfortable way for a parent or caretaker to feed a child using a bottle without the need for the caretaker to hold the bottle in place. To that end, the present invention is a baby pillow which may comprise a first arm, a second arm, a bottle holder, an attachment cushion, and an elastic band. The first arm and second arm flare outwards and extend back to encircle the head of the wearer, forming an annular shape. The outward flare of the arms prevents the arms from irritating or folding the ears of the wearer. The backs of the arms may be adjustably secured together at the back on tapered ends to accommodate different head and neck sizes of the wearer. The bottle holder may be located at the front of the baby pillow, at the joinder of the two arms. The bottle holder may comprise a divot and two ears, the divot and two ears forming a receptacle for a bottle. An elastic band may stretch between the first and second ear to adjustably secure a bottle into the bottle holder. The divot ideally slants downward towards the center of the baby pillow, so that a bottle placed in the bottle holder will be slanted downwards towards the mouth of the child wearing the baby pillow. In some embodiments, the front of the baby pillow near the bottle holder may be configured to resemble a visage of an animal to make the pillow more appealing to children, increasing comfortability of the child during use. The attachment cushion may be detachably attached to the bottom of the baby pillow to assist with height adjustment.

### BRIEF DESCRIPTION OF THE DRAWINGS

FIG. 1 is a top front perspective view of the present invention in accordance with at least one embodiment.

FIG. 2 is a bottom rear perspective view of the present invention in accordance with at least one embodiment.

FIG. 3 is a front elevation view of the present invention in accordance with at least one embodiment.

FIG. 4 is a rear elevation view of the present invention in accordance with at least one embodiment.

FIG. 5 is a left-side elevation view of the present invention in accordance with at least one embodiment.

FIG. 6 is a right-side elevation view of the present invention in accordance with at least one embodiment.

FIG. 7 is a top plan view of the present invention in accordance with at least one embodiment.

FIG. 8 is a bottom plan view of the present invention in accordance with at least one embodiment.

### DETAIL DESCRIPTIONS OF THE INVENTION

All illustrations of the drawings are for the purpose of describing selected versions of the present invention and are not intended to limit the scope of the present invention.

It should be understood that the articles “a”, “an”, and “the” refer to both the singular and plural of a component. For example, reference to “an elastic band 500” should include reference to “one elastic band”, “at least one elastic band”, and “a plurality of elastic bands”, unless otherwise explicitly stated.

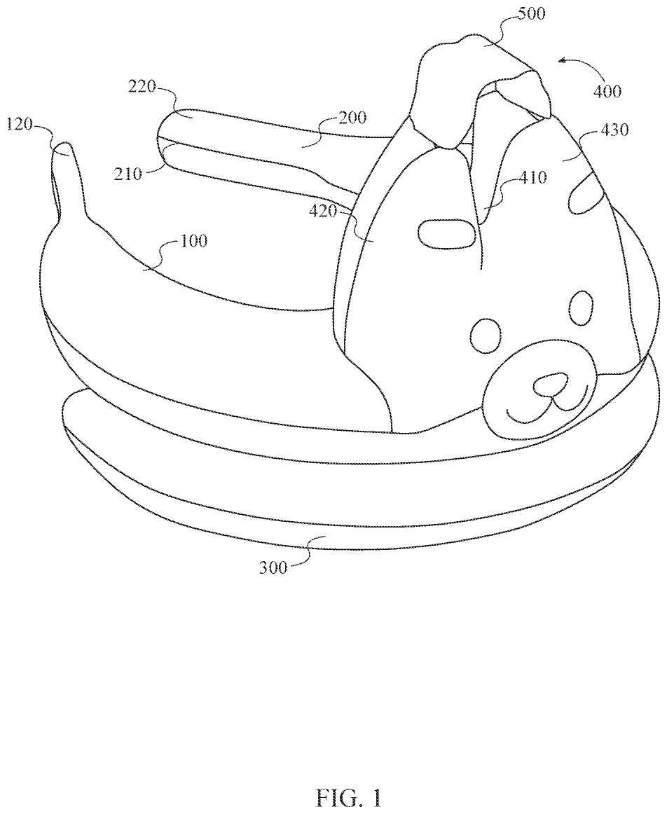

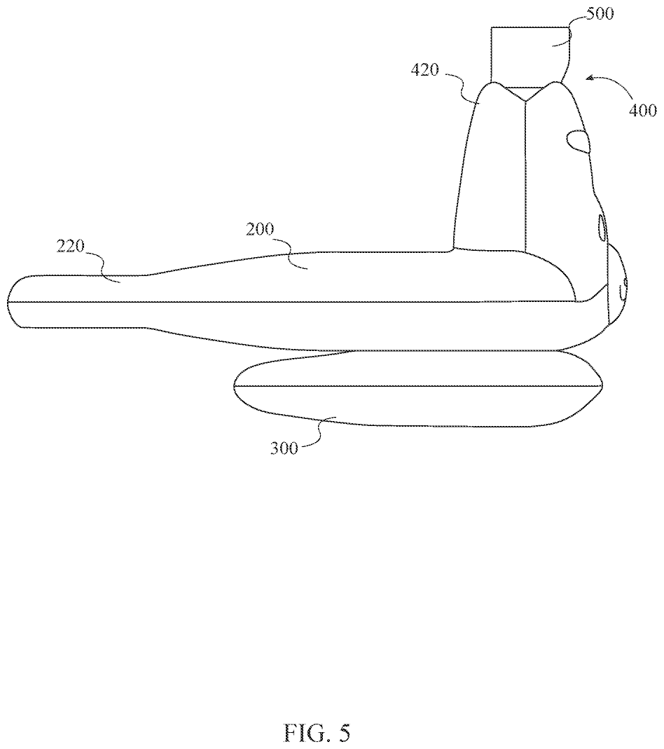

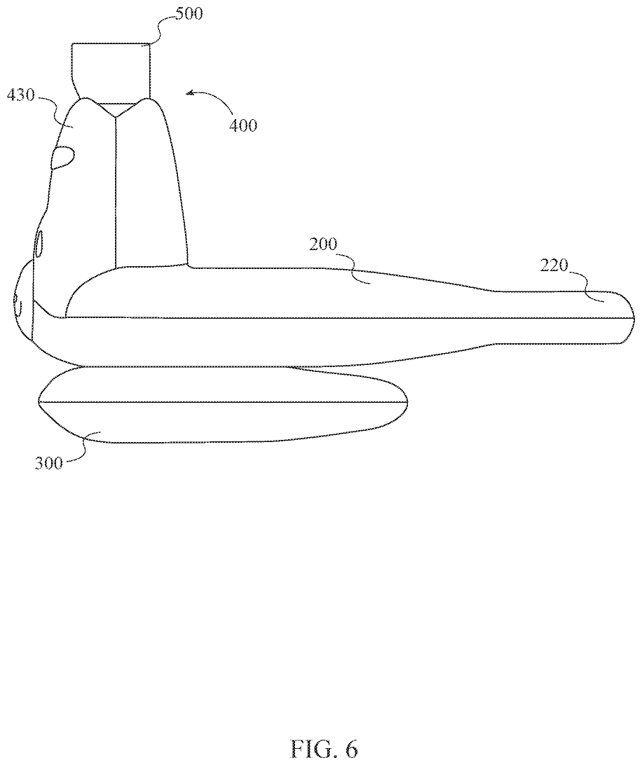

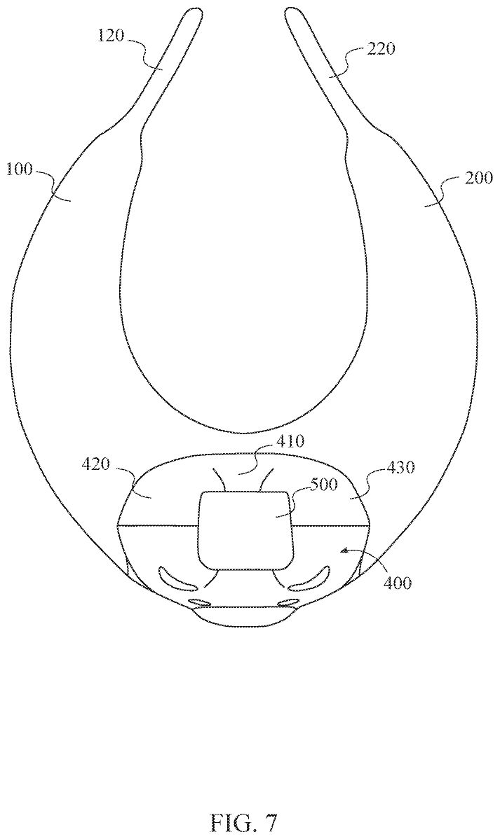

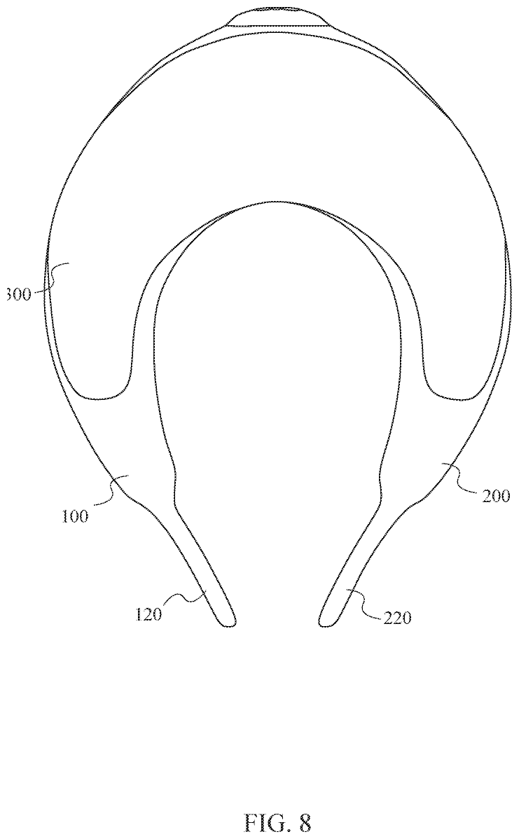

Referring now to FIGS. 1-8, The present invention is a baby pillow adapted for securing around the neck of a child while holding and directing a bottle towards the mouth of the child. The baby pillow may comprise a first arm 100, a second arm 200, a bottle holder 400, and an elastic band 500.

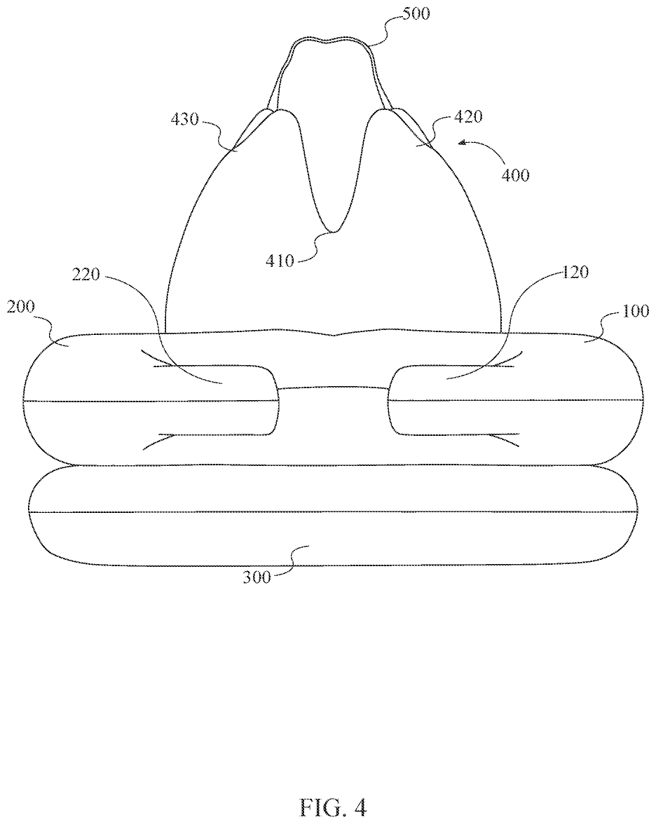

As shown in FIG. 1, The first arm 100 and second arm 200 may each be semi-annular in shape, such that they are shaped to extend around the neck of the child. The first arm 100 and second arm 200 may be flared outwards, such that the arms circle around the neck of the child and avoid applying pressure on the head or cars of the child by circling wide around the cars of the child and meeting in the back, as seen in FIG. 4.

The first arm 100 may further comprise a first tapered end 120. The first tapered end 120 may be located towards the rear of the arm, towards the area that encircles the back of the child's neck. Likewise, the second arm 200 may further comprise a second tapered end 220. The second tapered end 220 may be located towards the rear of the second arm 200, towards the area that encircles the back of the child's neck.

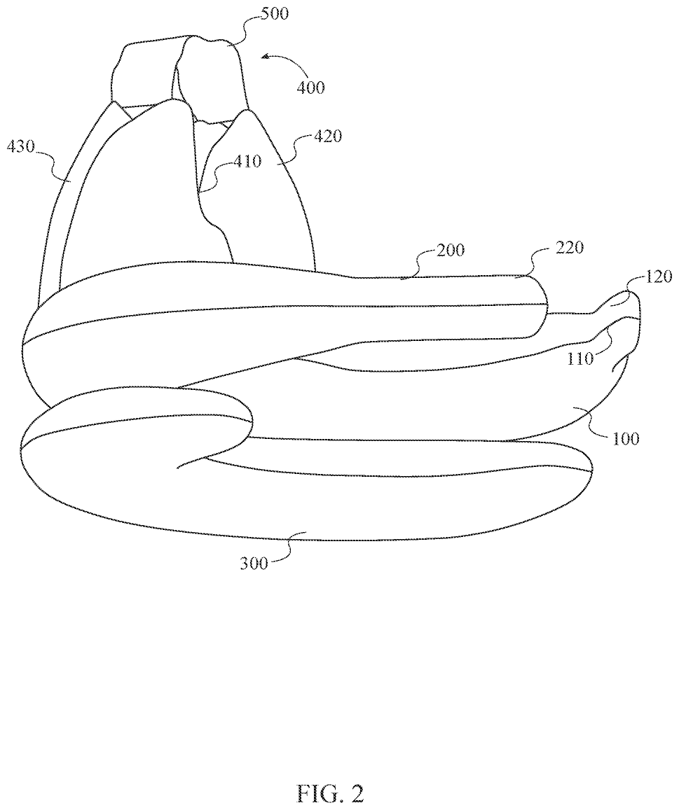

As shown in FIG. 2, the first arm 100 may further comprise a first fastener 110. As shown in FIG. 1, the second arm 200 may further comprise a second fastener 210. The first fastener 110 may comprise any fastening mechanism well-known in the art, such as hook-and-loop, adhesive, a button and hole, or any other similar fastener. In the ideal embodiment, the first fastener 110 comprises hook-and-loop. The second fastener 210 may comprise any fastening mechanism well-known in the art, such as hook-and-loop, adhesive, a button and hole, or any other similar fastener. In the ideal embodiment, the second fastener 210 comprises hook-and-loop.

In the ideal embodiment, as seen in FIG. 1 and FIG. 2, the first fastener 110 may be positioned on the first tapered end 120 of the first arm 100. The second fastener 210 may be positioned on the second tapered end 220 of the first arm 100. The first fastener 110 and second fastener 210 are adapted to connect to each other, such that the first arm 100 and the second arm 200 are detachably and adjustably attachable using the first fastener 110 and the second fastener 210. In the ideal embodiment, when attached, the first arm 100 and second arm 200 form an annular shape, such that the baby pillow encircles the neck of the wearer. In the ideal embodiment, the attachment point of the first fastener 110 and second fastener 210 may be variable, such as by comprising a strip of hook-and-loop, so that the attachment point may vary. The variable attachment point allows the diameter of the annular shape created by the first arm 100 and the second arm 200 to vary based on the point of attachment selected by a user. This variance allows the baby pillow to accommodate different shapes and sizes of necks as needed.

The attachment cushion 300 is adapted to provide additional height or padding to the baby pillow. The attachment cushion 300 may comprise a cushion fastener. The cushion fastener may be detachably attachable to the bottom of the bottle holder 400, such that the attachment cushion 300 is detachably attachable from the baby pillow as needed. If the user requires additional height, the attachment cushion 300 may be attached. If the user requires a lower height, the attachment cushion 300 may be detached. In the ideal embodiment, the cushion fastener comprises hook-and-loop. In the ideal embodiment, the attachment cushion 300 is detachably attachable from the bottom of the bottle holder 400 area of the baby pillow. In some embodiments, the attachment cushion 300 may be adapted to adjust the height in varying degrees, such as by varying the height using the cushion fastener, by removing or adding more than one attachment cushion 300, or by providing attachment cushions of varying heights. In some embodiments, the shape of the attachment cushion may mimic the shape of the first arm 100 and second arm 200, as show in FIG. 2.

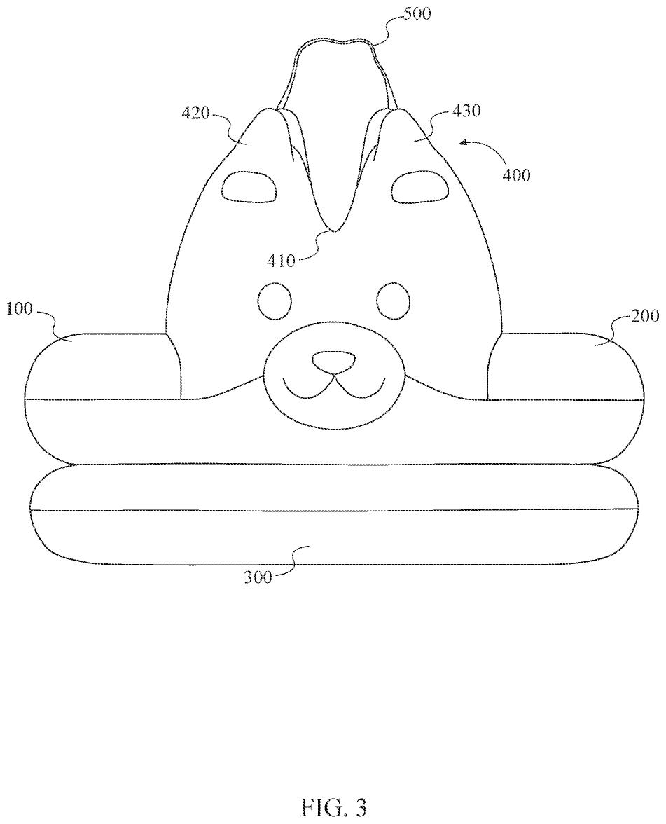

The bottle holder 400 may further comprise a divot 410, a first car 420, and a second car 430. The divot 410 is adapted to hold a bottle or other container in place. In the ideal embodiment, the divot 410 is slanted downwards at a steep angle towards the interior of the baby pillow, such that a bottle placed in the divot 410 will angle downwards towards the mouth of the child wearing the baby pillow. When the first arm 100 and second arm 200 are fastened, the slope of the divot 410 points towards the interior of the annular shape created by the arms. The first car 420 may be positioned on one side of the divot 410, with the second car 430 positioned on the opposite side laterally, as shown in FIG. 3. The divot 410 is thus ideally positioned between the first car 420 and the second car 430.

The elastic band 500 may comprise a high tensile elastic fabric, ideally having a thick width. The elastic band 500 may be attached at either end to one of the ears, such that the elastic band spans the gap between the first ear 420 and the second ear 430 over the divot 410. The elastic band 500 may be attached at a first band end to the first ear 420, and attached at a second band end to the second ear 430, such that the elastic band 500 arcs over the space between the first ear 420 and second ear 430. Thus, in the ideal embodiment, the first ear 420 and second ear 430 form two walls to hold a bottle, the divot 410 forms the floor, and the elastic band 500 provides an adjustable ceiling that holds the bottle in place during use. The elastic properties of the elastic band 500 allow a user to easily pull the band upward to insert or remove the bottle, allowing the bottle to be detachably secured to the baby pillow using the elastic band 500.

As shown in FIG. 3, in the ideal embodiment, the first ear 420, second ear 430, divot 410, and front of the baby pillow are arranged to form a visage of an animal. This appearance makes the baby pillow more friendly for children and improves the aesthetic appearance. Though the figures show a feline visage, it should be understood that any other visage or aesthetic decoration, including non-animal visages, are within the scope and spirit of the present invention.

Although the invention has been explained in relation to its preferred embodiment, it is to be understood that many other possible modifications and variations can be made without departing from the spirit and scope of the invention.

What is claimed is:

1. A baby pillow comprising:
a first arm;
a second arm;
a bottle holder;
an elastic band;
the bottle holder comprising a divot, a first ear, and a second ear;
the elastic band being attached at a first band end to the first ear;
the elastic band being attached at a second band end to the second ear;
the divot being angled downwards towards the center of the baby pillow;
the divot being positioned between the first ear and the second ear; and
wherein the elastic band is adapted to detachably secure a bottle to the divot.

2. The baby pillow of claim 1, further comprising:
the first arm comprising a first tapered end; and
the second arm comprising a second tapered end.

3. The baby pillow of claim 2, further comprising:
the first arm comprising a first fastener; and
the second arm comprising a second fastener.

4. The baby pillow of claim 3, further comprising:
the first fastener being positioned on the first tapered end;
the second fastener being positioned on the second tapered end; and
the first arm and second arm being detachably attachable using the first fastener and second fastener.

5. The baby pillow of claim 2, further comprising:
the first fastener and the second fastener comprising hook-and-loop.

6. The baby pillow of claim 1, further comprising:
an attachment cushion;
the attachment cushion comprising a cushion fastener; and
the attachment cushion being detachably attachable to the bottom of the bottle holder using the cushion fastener.

7. The baby pillow of claim 1, further comprising:
the first arm comprising a first fastener;
the second arm comprising a second fastener; and
the first arm and second arm being detachably attachable using the first fastener and second fastener.

8. The baby pillow of claim 7, further comprising:
the first arm and second arm being semi-annular.

9. The baby pillow of claim 8, further comprising:
the first arm and second arm forming an annular shape when attached, wherein the diameter of the annular shape varying based off the point of attachment of the first and second fastener.

10. The baby pillow of claim 1, further comprising:
wherein the first ear, second ear, divot, and front of the baby pillow are arranged to form a visage of an animal.

11. A baby pillow comprising:
a first arm;
a second arm;
a bottle holder;
an elastic band;
the bottle holder comprising a divot, a first ear, and a second ear;
the elastic band being attached at a first band end to the first ear;
the elastic band being attached at a second band end to the second ear;
the divot being angled downwards towards the center of the baby pillow;
the divot being positioned between the first ear and the second ear;
wherein the elastic band is adapted to detachably secure a bottle to the divot;
the first arm comprising a first tapered end;
the second arm comprising a second tapered end;
the first arm comprising a first fastener;
the second arm comprising a second fastener;
the first fastener being positioned on the first tapered end;
the second fastener being positioned on the second tapered end; and
the first arm and second arm being detachably attachable using the first fastener and second fastener.

12. The baby pillow of claim 11, further comprising:
the first arm and second arm being semi-annular.

13. The baby pillow of claim 12, further comprising:
the first arm and second arm forming an annular shape when attached, wherein the diameter of the annular shape varying based off the point of attachment of the first and second fastener.

14. The baby pillow of claim 11, further comprising:
an attachment cushion;
the attachment cushion comprising a cushion fastener; and
the attachment cushion being detachably attachable to the bottom of the bottle holder using the cushion fastener.

15. The baby pillow of claim 11, further comprising:
wherein the first ear, second ear, divot, and front of the baby pillow are arranged to form a visage of an animal.

16. The baby pillow of claim 11, further comprising:
the first fastener and the second fastener comprising hook-and-loop.

17. A baby pillow comprising:
a first arm;
a second arm;
an attachment cushion;
a bottle holder;
an elastic band;
the first arm comprising a first fastener;
the first arm comprising a first tapered end;
the second arm comprising a second fastener;
the second arm comprising a second tapered end;
the first fastener being positioned on the first tapered end;
the second fastener being positioned on the second tapered end;
the first arm and the second arm being semi-annular;
the first arm and the second arm being detachably attachable using the first fastener and second fastener;
the first arm and second arm forming an annular shape when attached, wherein the diameter of the annular shape varying based off the point of attachment of the first and second fastener;
the attachment cushion comprising a cushion fastener;
the attachment cushion being detachably attachable to the bottom of the bottle holder using the cushion fastener;
the bottle holder comprising a divot, a first ear, and a second ear;
the elastic band being attached at a first band end to the first ear;
the elastic band being attached at a second band end to the second ear;
the divot being angled downwards towards the interior of the annular shape;
the divot being positioned between the first ear and the second ear; and
wherein the elastic band is adapted to detachably secure a bottle to the divot.

18. The baby pillow of claim 17, further comprising:
wherein the first car, second car, divot, and front of the baby pillow are arranged to form a visage of an animal.

19. The baby pillow of claim 17, further comprising:
the first fastener and the second fastener comprising hook-and-loop.
